(19) United States
(12) Patent Application Publication
(10) Pub. No.: US 2009/0149996 A1
(43) Pub. Date: Jun. 11, 2009

(54) MULTIPLE INLET ABATEMENT SYSTEM

(75) Inventors: Youssef A. Loldj, Sunnyvale, CA (US); Miroslav Gelo, San Jose, CA (US); Manuel Diaz, San Jose, CA (US); Shaun Crawford, San Ramon, CA (US)

Correspondence Address: DUGAN & DUGAN, PC, 245 Saw Mill River Road, Suite 309, Hawthorne, NY, 10532, US

(73) Assignee: APPLIED MATERIALS, INC.

(21) Appl. No.: 11/950,938

(22) Filed: Dec. 5, 2007

(51) Int. Cl. G05D 7/00; B01J 19/00

(52) U.S. Cl. 700/266; 422/83

(57) ABSTRACT

A method of operating an electronic device manufacturing thermal abatement system is provided, including: flowing a gaseous effluent through an inlet into a thermal abatement reaction chamber; abating the effluent; flowing the abated effluent through an outlet out of the thermal abatement reaction chamber; using a pressure sensor to measure an inlet pressure; using the same pressure sensor to measure an outlet pressure; wherein the pressure sensor sequentially measures the inlet pressure and the outlet pressure; determining the difference between the inlet pressure and the outlet pressure; and if the difference between the inlet pressure and the outlet pressure exceeds a pre-determined pressure, diverting the flow of effluent away from the inlet. Numerous other aspects are provided.

### RELATED APPLICATIONS

The present application claims priority from U.S. Provisional Patent Application Ser. No. 60/868,720 entitled “MULTIPLE INLET ABATEMENT SYSTEM,” filed Dec. 5, 2006, which is hereby incorporated by reference herein in its entirety.

### FIELD OF THE INVENTION

The present invention relates to electronic device manufacturing, and more specifically to hazardous compound abatement systems having multiple inlets with inlet clog detection capabilities.

### BACKGROUND OF THE INVENTION

Gaseous effluents from the manufacturing of electronic materials and devices may include a wide variety of chemical compounds which are used and/or produced during manufacturing. During processing (e.g. physical vapor deposition, diffusion, etch PFC processes, epitaxy, etc.), some processes may produce undesirable byproducts including, for example, perfluorocompounds (PFCs) or byproducts that may decompose to form PFCs. PFCs are recognized to be strong contributors to global warming. These compounds may be harmful to human beings and/or the environment (hereinafter referred to as “harmful compounds”). The harmful compounds must be removed from the gaseous effluent before the gaseous effluent is vented into the atmosphere.

Harmful compounds may be removed from the effluents or converted into non-harmful compounds via a process known as abatement. During an abatement process, the harmful compounds used and/or produced by electronic device manufacturing processes may be destroyed or converted to less harmful or non-harmful compounds (abated) which may be further treated or emitted to the atmosphere.

It is known that effluent may be abated in a thermal abatement reactor which heats and burns, or oxidizes, the effluent, thereby converting the harmful compounds into less harmful or non-harmful compounds. The thermal reactor may include a pilot device, a fuel supply, an oxidant supply, burner jets, effluent inlets and abated effluent outlets.

Thermal abatement units typically have the capacity to abate the effluent from several process chambers. For example, some thermal abatement units have multiple inlets, and each may be connected to a different process chamber. During operation of the thermal abatement unit, it is possible for solids, e.g., abatement reaction products, to build up in an inlet, and impede the effluent from the process chamber which feeds that inlet from freely entering the thermal abatement unit, causing the effluent pressure at the inlet to build. This may negatively impact the process tool.

Conventional methods and apparatus for monitoring such pressure build up are expensive and complex. As such, a need exists for improved methods and apparatus for monitoring inlet pressure of an abatement system.

### SUMMARY OF THE INVENTION

In some embodiments, a method of operating an electronic device manufacturing thermal abatement system is provided, including: flowing a gaseous effluent through an inlet into a thermal abatement reaction chamber; abating the effluent; flowing the abated effluent through an outlet out of the thermal abatement reaction chamber; using a pressure sensor to measure an inlet pressure of the inlet; using the same pressure sensor to measure an outlet pressure of the outlet; wherein the pressure sensor sequentially measures the inlet pressure and the outlet pressure; determining a difference between the inlet pressure and the outlet pressure; and if the difference between the inlet pressure and the outlet pressure exceeds a pre-determined pressure, diverting the flow of effluent away from the inlet.

In other embodiments a thermal abatement reactor inlet and outlet pressure measurement system is provided, including: one or more gas inlets, each gas inlet having a pressure port; one or more gas outlets, each gas outlet having a pressure port; and a pressure sensor selectively connected with more than one of the pressure ports.

In still other embodiments an electronic device manufacturing gaseous effluent abatement system is provided, including: one or more process chambers; a thermal abatement reactor having one or more effluent inlets and one or more outlets, the one or more inlets coupled to the one or more process chambers and adapted to receive effluent from the one or more process chambers, wherein each inlet and each outlet comprises a pressure port; and a pressure sensor selectively connected to more than one pressure port; wherein each process chamber is adapted to flow gaseous effluent through a reaction chamber inlet into the thermal abatement reactor. Numerous other aspects are provided.

Other features and aspects of the present invention will become more fully apparent from the following detailed description, the appended claims and the accompanying drawings.

### BRIEF DESCRIPTION OF THE DRAWINGS

FIG. 1 is a schematic view of a thermal abatement system including a inlet clog detection system.

FIG. 2 is a schematic view of the inlet clog detection system.

FIG. 3 is a schematic view of an alternate embodiment of the clog detection system.

### DETAILED DESCRIPTION

As stated, thermal abatement units typically have the capacity to abate the effluent from several process chambers. For example, some thermal abatement units have up to six inlets, and each may be connected to a different process chamber. During operation of the thermal abatement unit, it is possible for solids, e.g., abatement reaction products, to build up in an inlet, and impede the effluent from the process chamber which feeds that inlet from freely entering the thermal abatement unit, causing the effluent pressure at the inlet to build. This may negatively impact the process tool. When this happens the inlet needs to be shut down and the effluent from the process chamber stopped or diverted to another abatement inlet.

It is known to monitor inlet clogging by comparing the inlet pressure at each inlet to the outlet pressure of the thermal abatement unit. When the difference in pressure between an inlet and the outlet of the thermal abatement unit exceeds a predetermined pressure, the operator or system may determine that that inlet is clogged and appropriate action may be taken. Typically, pressure sensors may be located at each inlet and the outlet of the thermal abatement unit. Thus, in a six inlet thermal abatement unit, there may be seven pressure sensors. Pressure sensors are expensive, however, and so a need exists for an apparatus and method that provides at least the same functionality as the multiple pressure sensor apparatus but at lower cost.

The present invention provides an improved thermal abatement system which can abate process gases from one or more process tools. More specifically, the present invention reduces the capital cost of a thermal abatement reactor and at the same time provides an inlet clog detection system. In addition a method and apparatus for determining if the detection system has suffered a failure is provided.

As stated, a modern thermal abatement reactor may have six inlets. A conventional clog detection system used with such a reactor may include seven pressure sensors, one for each reactor inlet and one for the reactor outlet. Each pressure sensor adds to the expense and complexity of the thermal abatement system and is a part which may fail. In some embodiments, the present invention reduces the number of pressure sensors required in such a thermal abatement system to as few as one pressure sensor. For example, each inlet and the outlet to the thermal abatement unit may be selectively connected to a single pressure sensor through a pressure port on each inlet/outlet, and conduits which connect each pressure port with the pressure sensor. The selectivity of the fluid connection may be accomplished by locating valves between each inlet/outlet and the pressure sensor. To measure the pressure of a particular inlet/outlet, the valve between the sensor and the inlet/outlet may be opened, while all the other valves are kept closed. This process may be repeated for each inlet/outlet in sequence, thus providing a pressure measurement of each inlet/outlet using a single pressure sensor. The pressure measurements obtained in this fashion may be used in at least the same ways as the pressure measurements obtained by conventional multi-pressure sensor inlet clog detection systems.

In these and other embodiments, the single, or first, pressure sensor may be supplemented by a second pressure sensor which may be in fluid communication with the first pressure sensor so that when an inlet/outlet is selectively connected to one pressure sensor, it is also connected to the second pressure sensor. Connected thus, the pressure sensors should report the same measurement. If one pressure sensor fails, the pressure sensors may begin to report different measurements. In this scenario, one or both sensors may be replaced without shutting down the thermal abatement unit, and with the continued operation of the inlet clog detection system.

### Thermal Abatement System

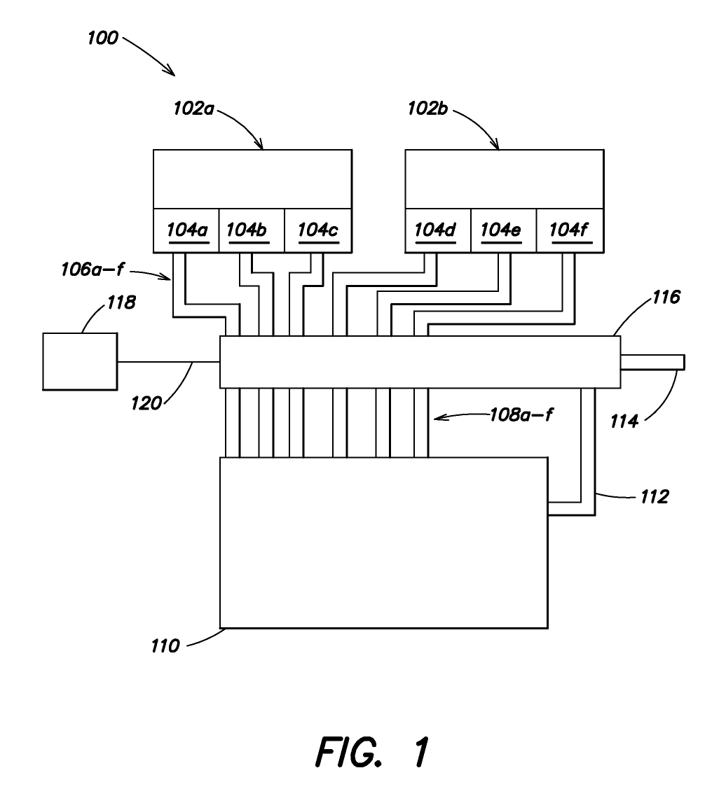

FIG. 1 is a schematic depiction of an improved thermal abatement system 100 of the present invention.

Process tools 102a,b each may have three process chambers 104a-f. Each process chamber 104a-f may exhaust process gases through conduits 106a-f, into inlets 108a-f of thermal abatement reactor 110, wherein the process gases may be thermally abated, such as, for example, by being oxidized. Following abatement, the abated process gases may be exhausted from outlet 112 and through conduit 114, where the abated gases may be further treated, passed to a house exhaust system or otherwise released to the atmosphere. Fewer or more process tools, process chambers per process tool, exhaust conduits, inlets and/or outlets may be used.

Thermal abatement system 100 may also include an inlet clog detection system 116, which is in fluid communication with inlets 108a-f and outlet 112. The inlet clog detection system 116 may measure an inlet pressure of each inlet 108a-f and an outlet pressure of outlet 112, and report the measurements to controller 118 by information communication means 120. Controller 118 may be a microprocessor, a microcontroller, a dedicated hardware circuit, software, a combination of the same, or the like. In one embodiment, the controller 118 may be a programmable logic controller. Communication means 120 may be a wire, wireless, fiber or other suitable connection. Although controller 118 is depicted in FIG. 1 as being separate from the inlet clog detection system 116, for ease of description it may be considered and described as a part of and/or may be part of the inlet clog detection system 116, despite the fact that it may perform functions in addition to clog detection.

Controller 118 may further be connected to a system (not shown) for diverting the flow of effluent away from any particular inlet to either another inlet of the same thermal abatement reactor, or to an inlet of a second thermal abatement reactor.

### Inlet Clog Detection System

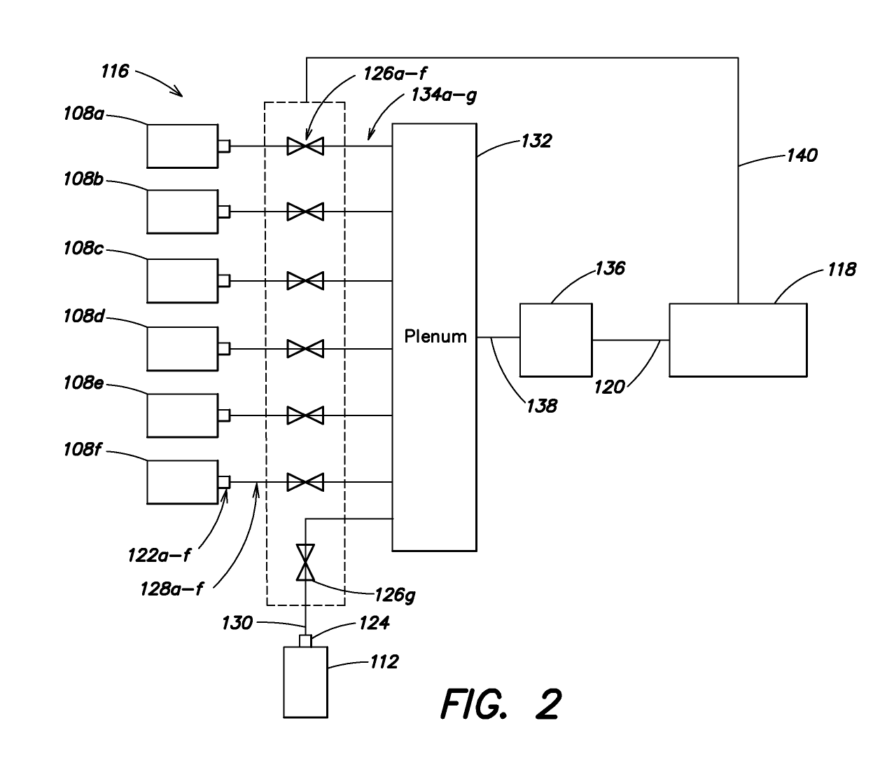

FIG. 2 is a schematic drawing of at least one embodiment of the inlet clog detection system 116 of FIG. 1. In this embodiment, inlets 108a-f may include pressure ports 122a-f, and outlet 112 may include pressure port 124. Pressure ports 122a-f and 124 may be connected to valves 126a-g by conduits 128a-f and 130, respectively. Valves 126a-g may be connected to optional plenum 132 by conduits 134a-g. Plenum 132 may be in fluid communication with a pressure sensor 136 through conduit 138. Instead of a plenum, a simple pipe (not shown) may connect conduits 134a-g to conduit 138. These ports, conduits and valves enable the pressure sensor 136 to be remote from, yet selectively in fluid communication with, the inlets 108a-f and outlet 112, as will be described in more detail below. Any suitable pressure sensor may be employed, such as a Sentra low pressure sensor or similar sensor. In some embodiments, an analog or other operating voltage may be supplied to pressure sensor 136 to excite operation of the pressure sensor.

In some embodiments, valves 126a-g may be operated to selectively enable pressure sensor 136 to measure the pressure of any one inlet/outlet at a time. For example, when valve 126a is open and valves 126b-g are closed, inlet 108a may be in fluid communication with remote pressure sensor 136, enabling the sensor 136 to measure the pressure of the fluid within inlet 108a. After the pressure sensor 136 measures the pressure of the fluid within inlet 108a, valve 126a may be closed, and inlet 108a may no longer be in fluid connection with pressure sensor 136. Another valve may then be opened and the process repeated, until the pressure of each inlet/outlet has been measured. This process may be repeated continuously or periodically.

Controller 118 may be connected to pressure sensor 136 through communication means 120, over which the pressures measured by the pressure sensor 136 may be reported to controller 118. Controller 118 may be connected to valves 126a-g by communication channel 140, through which controller 118 may command valves 126a-g individually to open or close. In an alternate embodiment, a separate controller may be used to command valves 126a-g to open or close. The communication channel 140 may include a wired, wireless, fiber or other communication channel.

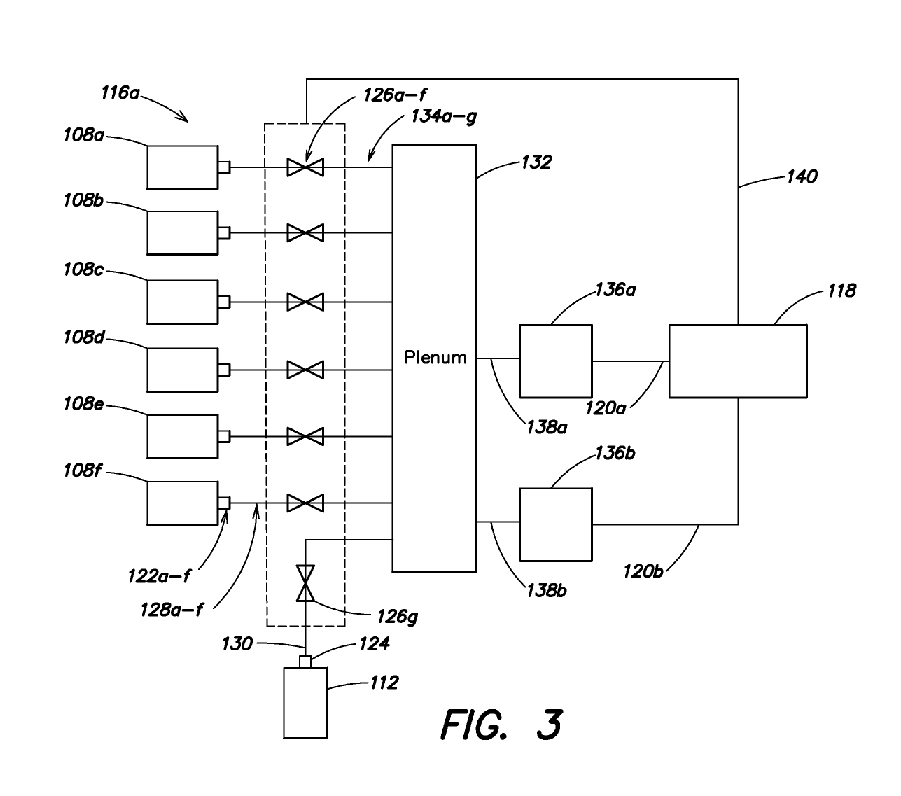

FIG. 3 is a schematic representation of inlet clog detection system 116a which may be similar to the inlet clog detection system 116 of FIG. 2, with the addition of a second pressure sensor 136b connected to plenum 132 by conduit 138b, and to controller 118 by communication means 120b. The second pressure sensor 136b may be used by controller 118 together with first pressure sensor 136a to detect a failure of one of the pressure sensors 136a,b. In addition to failure detection, dual pressure sensors 136a,b may be used as a back-up system, whereby the thermal abatement system 100 may continue to be operated with one failed pressure sensor. In additional embodiments, the thermal abatement system 100 may continue to be operated using one operational pressure sensor, during replacement of a failed pressure sensor.

### Operation of the Thermal Abatement System

With reference to FIG. 1, process effluent from process chambers 104a-f may be directed through conduits 106a-f into thermal abatement reactor inlets 108a-f. The process effluent may be thermally abated in thermal abatement reactor 110 and then exhausted through outlet 112 into conduit 114, which may carry the effluent to further abatement processes or to the house scrubber or exhaust system, etc. Inlet clog detection system 116 may, either continuously or periodically, measure the pressure at each inlet 108a-f and the outlet 112, in order to detect the clogging of any inlet 108a-f. The inlet clog detection system 116 may report the measured pressures to controller 118. In some embodiments, controller 118 may be programmed with a normal pressure range in which a non-clogged inlet will operate. Thus, for example, if during operation of the thermal abatement system 100 the pressure of inlet 108a rises above its normal pressure range, controller 118 may determine that inlet 108a is becoming or has become clogged. The response to this determination may be that the process chamber 104a which is supplying effluent to inlet 108a is shut down or that the effluent from process chamber 104a is diverted through a system of conduits (not shown) to an inlet other than inlet 108a or to a different thermal abatement reactor (not shown). The thermal abatement system 100 may continue to be operated, for example, until such time as a predetermined number of additional inlets are determined to be becoming clogged or to have become clogged and are taken off line. At that time, maintenance may be performed on the system 100 to clean the inlets 108a-f.

In an alternate embodiment, controller 118 may compare inlet pressures to the outlet pressure. A baseline pressure differential may be established for each inlet 108a-f, and if the pressure differential for any inlet increases beyond the baseline pressure differential by a predetermined amount, controller 118 may determine that the inlet is clogged or becoming clogged and may take any appropriate action, such as the actions described above.

### Operation of the Inlet Clog Detection System

The inlet clog detection system 116, see FIG. 2, may be operated so that the pressure of individual inlets 108a-f and the outlet 112 may be measured individually and in any desired sequence. In some embodiments, each inlet pressure may be measured, one after the other, and then the outlet pressure may be measured. In other embodiments, the outlet pressure may be measured between measurements taken of each inlet pressure. Any desired measurement pattern may be used.

In some embodiments, each inlet 108a-f and outlet 112 may selectively be in fluid communication with pressure sensor 136 through a series of pressure ports 122a-f and 124, conduits 128a-f, 124 and 134a-g, valves 126a-g and optionally a plenum 132. Valves 126a-g may be, for example, gate valves and may be located such that a fluid communication path from each inlet 108a-f and the outlet 112 to pressure sensor 136 may be selectively opened (the inlet or outlet engaged) or closed (the inlet or outlet disengaged). When an inlet or outlet is engaged, pressure sensor 136 may sense the inlet's or outlet's pressure.

In order to measure the pressure of a particular inlet or outlet, all of valves 126a-g may be closed except for one valve, which is located between the pressure sensor 136 and the inlet or outlet to be measured. Pressure sensor 136 may then sense the pressure of the particular inlet or outlet. Once a pressure measurement has been made by pressure sensor 136, the inlet clog detection system 116 may reconfigure valves 126a-g to measure the pressure of a different inlet or outlet. This reconfiguration may include closing the open valve, and opening one of the closed valves. The inlet clog detection system 116 may use controller 118 to operate valves 126a-g through communication channel 140. A controller, such as a microprocessor, a microcontroller, a dedicated hardware circuit, software, a combination of the same, a programmable logic controller, etc., will be used to control valves 126a-g in the following illustrations, but it will be recognized that valves 126a-g may be operated manually.

When controller 118 configures valves 126a-g to measure a first inlet or outlet pressure, and then reconfigures valves 126a-g to measure a second inlet or outlet pressure, controller 118 may close a first valve completely before it opens a second valve. Alternatively, controller 118 may begin opening the second valve while it is closing the first valve. This alternative method may reduce pressure surges and oscillations at pressure sensor 136.

Pressure sensor 136 may be configured to report inlet and outlet pressure measurements to controller 118 through information communication means 120. Controller 118 may be configured to compare a reported pressure for each inlet to a pressure expected for the inlet, (e.g., the expected pressure may have been programmed into controller 118 or be available to controller 118 in a database or through some other suitable means). Controller 118 may be further configured to respond to a reported pressure which is outside of an expected pressure range for an inlet. For example, if the measured pressure for a first inlet is greater than the range of pressures expected for the first inlet, controller 118 may be configured to determine that the first inlet is clogged or becoming clogged. Upon making such a determination, controller 118 may be configured to command the diversion of effluent flowing to the first inlet to a second inlet or to a different thermal abatement reactor. Alternatively, controller 118 may be configured to command a shutdown of a process chamber which is feeding effluent to the first inlet. In the event that the measured pressure for the first inlet is less than the range of pressures expected for the first inlet, controller 118 may be configured to issue an alarm if the pressure is below a first level and/or shut down the system if the pressure is below a second level.

In yet other embodiments, controller 118 may be configured to calculate a pressure differential for each inlet 108a-f. This pressure differential may be the difference between the pressure reported for the inlet 108a-f and the pressure reported for the outlet 112. Controller 118 may be further configured to compare the pressure differential calculated for an inlet 108a-f with the pressure differential expected for that inlet (e.g., the expected pressure differential may be programmed into controller 118 or be available to controller 118 in a database or by some other suitable means). Controller 118 may be still further configured to respond to an inlet's calculated inlet/outlet pressure differential which falls outside of the expected range for that inlet. For example, if the calculated pressure differential for an inlet is above an expected range for that inlet, controller 118 may be configured to determine that the inlet is clogged or becoming clogged. Controller 118 may be further configured to respond to such a determination in the ways which were described above. If the pressure differential is below the expected range, controller 118 may be configured to issue an alarm if the pressure is below a first level and/or shut down the system if the pressure is below a second level.

In yet other embodiments, controller 118 may keep a record of some or all of the preceding pressure measurements for each inlet 108a-f. The record retention may begin when the thermal abatement system 100 is first brought on line, for example after maintenance, and a baseline pressure for each inlet 108a-f may be established at that time. Thereafter the inlet clog detection system 116 of this embodiment may operate similarly to any of the embodiments previously described, except that instead of comparing reported pressures to expected pressures which have been either programmed into controller 118 or provided to controller 118 from a database, the reported pressures are compared to the baseline pressures developed by controller 118. Controller 118's response to unexpected pressures, whether greater or less than the expected, may be similar to that described above in other embodiments under similar circumstances.

### Operation of the Failure Detection and Backup Inlet Clog Detection System

In some additional embodiments, the inlet clog detection system 116a of FIG. 3 is similar to the inlet clog detection system 116 of FIG. 2, with the exception that instead of a single pressure sensor 136, redundant pressure sensors 136a,b are provided. Inlet clog detection system 116a may include all of the functionality of inlet clog detection system 116 described with respect to FIG. 2 above. In addition, controller 118 may receive reported pressure measurements from pressure sensors 136a,b via communication means 120a,b. Controller 118 may be configured to compare some or all reported pressure measurements received from the two pressure sensors 136a,b. Over time, if neither pressure sensor 136a,b has failed, the difference, if any, in the pressures reported by pressure sensor 136a and pressure sensor 136b for a particular inlet or outlet may not change substantially. If, however, one of the pressure sensors does fail, the two pressure sensors may begin reporting different pressures for a particular inlet or outlet. Controller 118 may be configured to provide a warning alert in such a case and/or may be configured to shut down the thermal abatement system 100.

In some of these and other embodiments, controller 118 may be configured to determine which pressure sensor has failed. In such a case, the failed sensor may be replaced, with or without shutting down the thermal abatement system 100. For example, if the pressure sensors 136a,b begin to provide diverging pressure measurements, the measurements from one of the pressure sensors 136a,b may continue to indicate that all of the inlets 108a-f are operating nominally, while the pressure measurements provided by the other pressure sensor may indicate that one or more of the inlets 108a-f is operating at a lower or higher pressure than the inlet's expected pressure. Controller 118 may be further configured to determine that a pressure sensor has failed if the pressure sensor reports that all of the pressures measured by the sensor are drifting higher or lower, while the other pressure sensor is reporting steady pressures.

The foregoing description discloses only exemplary embodiments of the invention. Modifications of the above disclosed apparatus and methods which fall within the scope of the invention will be readily apparent to those of ordinary skill in the art. For instance, the pressure at the outlet of the abatement reactor, scrubber or other location may be compared to the pressure of an inlet.

Accordingly, while the present invention has been disclosed in connection with exemplary embodiments thereof, it should be understood that other embodiments may fall within the spirit and scope of the invention, as defined by the following claims.

What is claimed is:

1. A thermal abatement reactor inlet and outlet pressure measurement system comprising:
one or more gas inlets, each gas inlet having a pressure port;
one or more gas outlets, each gas outlet having a pressure port; and
a pressure sensor selectively connected with more than one of the pressure ports.

2. The pressure measurement system of claim 1 wherein each pressure port comprises a valve which is adapted to selectively engage or disengage the pressure port and the pressure sensor.

3. The pressure measurement system of claim 2 further comprising a controller which is adapted to receive pressure measurements from the pressure sensor.

4. The pressure measurement system of claim 3 wherein the controller is further adapted to compare the pressure measurements received from the pressure sensor with expected pressures.

5. The pressure measurement system of claim 3 wherein the controller is further adapted to receive pressure measurements from the pressure sensor and to calculate a pressure differential between a gas inlet and a gas outlet.

6. The pressure measurement system of claim 3 wherein the controller is further adapted to receive pressure measurements from the pressure sensor and to develop a baseline pressure for each of the inlets.

7. The pressure measurement system of claim 2 further comprising a controller which is adapted to operate one or more of the valves independently to engage or disengage one or more pressure ports and the pressure sensor.

8. An electronic device manufacturing gaseous effluent abatement system comprising:
one or more process chambers;
a thermal abatement reactor having one or more effluent inlets and one or more outlets, the one or more inlets coupled to the one or more process chambers and adapted to receive effluent from the one or more process chambers, wherein each inlet and each outlet comprises a pressure port; and
a pressure sensor selectively connected to more than one pressure port.

9. The abatement system of claim 8 further comprising a valve located between each pressure port and the pressure sensor, wherein each valve is adapted to selectively engage or disengage a respective pressure port and the pressure sensor.

10. The abatement system of claim 9 further comprising a controller which is adapted to cause one or more of the valves to independently engage or disengage a respective pressure port and the pressure sensor.

11. The abatement system of claim 9 further comprising a controller which is adapted to receive an inlet pressure measurement of an inlet from the pressure sensor for each inlet.

12. The abatement system of claim 11 wherein the controller is further adapted to compare the received inlet pressure measurement to an expected pressure value for each inlet and is further adapted to, upon determining that the received inlet pressure measurement exceeds the expected pressure value, divert a flow of effluent away from the inlet.

13. A method of operating an electronic device manufacturing thermal abatement system comprising:
flowing a gaseous effluent through an inlet into a thermal abatement reaction chamber;
abating the effluent;
flowing the abated effluent through an outlet out of the thermal abatement reaction chamber;
using a pressure sensor to measure an inlet pressure of the inlet;
using the same pressure sensor to measure an outlet pressure of the outlet;
wherein the pressure sensor sequentially measures the inlet pressure and the outlet pressure;
determining a difference between the inlet pressure and the outlet pressure; and
if the difference between the inlet pressure and the outlet pressure exceeds a pre-determined pressure, diverting the flow of effluent away from the inlet.

14. The method of claim 13 wherein the effluent which is diverted away from the inlet is directed into a different inlet of the same, or of a different, thermal abatement reaction chamber.

15. The method of claim 14 wherein a controller is used to determine the difference between the inlet pressure and the outlet pressure.

16. The method of claim 13 wherein a controller operates a first valve to selectively engage or disengage the pressure sensor and a pressure port on the inlet and operates a second valve to selectively engage or disengage the pressure sensor and a pressure port on the outlet.

17. The method of claim 13 wherein the gaseous effluent flows from more than one process chamber into more than one inlet of the thermal abatement reaction chamber.

18. The method of claim 17 wherein each inlet is connected to a valve which is operated by a controller to selectively engage or disengage the pressure sensor and its respective inlet valve.

19. The method of claim 18 wherein the controller operates the valves such that the pressure of effluent is measured at only one inlet at a time.
